(19) United States
(12) Patent Application Publication
(10) Pub. No.: US 2016/0018308 A1
(43) Pub. Date: Jan. 21, 2016

(54) HARDNESS TESTER

(71) Applicant: MITUTOYO CORPORATION, Kanagawa (JP)

(72) Inventors: Masanobu KATAOKA, Miyazaki (JP); Takayuki YAMADA, Kanagawa (JP)

(73) Assignee: MITUTOYO CORPORATION, Kanagawa (JP)

(21) Appl. No.: 14/739,490

(22) Filed: Jun. 15, 2015

(30) Foreign Application Priority Data
Jul. 16, 2014 (JP) 2014-145599

(51) Int. Cl. G01N 3/42

(52) U.S. Cl. CPC G01N 3/42

(57) ABSTRACT

A hardness tester includes: a tester main body, an inputter receiving an operation input from a user, a controller controlling an entirety of the hardness tester including the inputter, and a display which displays a predetermined image by being controlled by the controller. The controller includes a measurement procedure suggester and a suggestion switcher. The measurement procedure suggester suggests a procedure for measuring an indentation dimension value to the user. When receiving an operation input for proceeding to a subsequent procedure via the inputter, the suggestion switcher switches suggestions from the measurement procedure suggester and suggests the subsequent procedure to the user.

### CROSS-REFERENCE TO RELATED APPLICATIONS

The present application claims priority under 35 U.S.C. §119 of Japanese Application No. 2014-145599, filed on Jul. 16, 2014, the disclosure of which is expressly incorporated by reference herein in its entirety.

### BACKGROUND OF THE INVENTION

1. Field of the Invention

The present invention relates to a hardness tester.

2. Description of Related Art

Conventionally, hardness testers that perform hardness testing of a work piece (such as Vickers hardness and Brinell hardness) are known, the testers forming an indentation by pressing an indenter against a surface of the work piece and by measuring a dimension value of a length and the like of an indentation border. (see Japanese Patent Laid-open Publication 2013-050379). A hardness tester described in Japanese Patent Laid-open Publication 2013-050379, for example, forms a square shaped indentation by pressing an indenter against a surface of a work piece, then measures a length of a diagonal line of an indentation border by designating an apex of the indentation by a user. Based on the length of the diagonal line, the hardness tester calculates the Vickers hardness of the work piece.

In such a hardness tester, a shape of an indenter or a designated portion of an indentation border varies by a testing method. For example, the shape of the indenter is a quadrangular pyramid in the Vickers hardness test, but a sphere in the Brinell hardness test. In addition, the designated portion of the indentation border is a diagonal length in the Vickers hardness test, but it is a crack length in a fracture toughness test. Therefore, the user should have an abundant knowledge of the hardness testers. For example, there is a concern that an inexperienced user operating the hardness tester will not be able to easily determine the designated portion of the indentation border.

### SUMMARY OF THE INVENTION

An advantage of the present invention is to provide a hardness tester capable of easily determining a designated portion of an indentation border.

The hardness tester of the present invention performs hardness testing of a work piece by forming an indentation by pressing an indenter against a surface of the work piece, and by measuring a dimension value of the indentation (indentation dimension value). The hardness tester includes, an inputter receiving an operation input from a user; and a controller controlling an entirety of the hardness tester including the inputter. The controller includes, a measurement procedure suggester which suggests a procedure for measuring the indentation dimension value to the user; and a suggestion switcher switches, when receiving an operation input for proceeding to a next procedure via the inputter, suggestions from the measurement procedure suggester to suggest the next procedure to the user.

According to this configuration, the hardness tester can suggest the procedure for measuring the indentation dimension value to the user, since the measurement procedure suggester is included. When receiving the operation input for proceeding to the next procedure via the inputter, the hardness tester can switch suggestions from the measurement procedure suggester to suggest the next procedure to the user, since the suggestion switcher is included. According to the present invention, the user can easily determine the designated portion of the indentation border based on the suggestion from the measurement procedure suggester.

In the present invention, the hardness tester includes a display which displays a predetermined image by being controlled by the controller. The measurement procedure suggester suggests the procedure for measuring the indentation dimension value to the user, by displaying on the display a plurality of icons which are images of each procedure for measuring the indentation dimension value. The suggestion switcher preferably switches suggestions from the measurement procedure suggester to suggest the next procedure to the user by causing an icon showing the next procedure to be emphasized among a plurality of icons, while not emphasizing the icon showing the current procedure.

According to this configuration, the measurement procedure suggester suggests the procedure for measuring the indentation dimension value to the user, by displaying on the display a plurality of icons which are images of each procedure for measuring the indentation dimension value. Therefore, the user can intuitively determine the designated portion of the indentation border with reference to these icons. Thus, according to the present invention, the user can easily determine the designated portion of the indentation border based on the suggestion from the measurement procedure suggester.

According to the present invention, the suggestion switcher switches suggestions from the measurement procedure switcher to suggest the next procedure to the user, by causing the icon showing the next procedure to be emphasized among a plurality of icons, while not emphasizing the current icon. Therefore, the user only needs to pay attention to the icon being emphasized, and can even more easily determine the designated portion of the indentation border based on the suggestion from the measurement procedure suggester.

In the present invention, it is preferable to initialize suggestions from the measurement procedure suggester, when forming an indentation by pressing an indenter against a surface of a work piece, the suggestion switcher causing an icon indicating a first procedure to be emphasized, while not emphasizing the icons indicating other procedures.

According to this configuration, when forming an indentation by pressing an indenter against a surface of a work piece, the suggestion switcher can automatically initialize suggestions from the measurement procedure suggester when starting a test, due to an initialization of suggestions from the measurement procedure suggester. Thus, according to the present invention, it is possible to improve convenience of the hardness tester.

In the present invention, when receiving the operation input for returning to a previous procedure via the inputter, the suggestion switcher preferably switches suggestions from the measurement procedure suggester to suggest the previous procedure to the user.

According to this configuration, when receiving the operation input for returning to the previous procedure via the inputter, the suggestion switcher switches suggestions from the measurement procedure suggester to suggest the previous procedure to the user. Therefore, the user can easily restore to a former condition by simply performing the operation input for returning to the previous procedure via the inputter, even if the user mistakenly operates the operation input for proceeding to the next procedure via the inputter. Thus, according to the present invention, it is possible to improve convenience of the hardness tester.

In the present invention, the suggestion switcher preferably receives the input of the indentation dimension value as the operation input for proceeding to a next procedure.

According to this configuration, the suggestion switcher receives the input of the indentation dimension value as the operation input for proceeding to the next procedure. Therefore, the user can switch suggestions from the measurement procedure suggester to the next procedure by simply entering the indentation dimension value. Thus, according to the present invention, it is possible to improve convenience of the hardness tester.

In the present invention, when receiving the operation input for returning to the previous procedure via the inputter, the suggestion switcher preferably deletes the indentation dimension value entered when the current procedure is processed.

According to this configuration, when receiving the operation input for returning to a previous procedure via the inputter, the suggestion switcher deletes the indentation dimension value entered when the current procedure is processed. Therefore, the user can delete the indentation dimension value entered when the current procedure is processed by simply performing the operation input for returning to the previous procedure via the inputter. Thus, according to the present invention, it is possible to improve convenience of the hardness tester.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a block diagram illustrating a schematic configuration of a hardness tester according to a first embodiment of the present invention;

FIG. 2 is a schematic view illustrating an external appearance of the hardness tester when viewed from the front;

FIG. 3 is a schematic view illustrating an image displayed on a touch panel;

FIG. 4 is a flowchart illustrating a case where a test is performed with the hardness tester;

FIGS. 5A to 5D illustrate states of switching suggestions from a measurement procedure suggester at a suggestion switcher;

FIG. 6 illustrates an example of the present invention being applied to the Vickers hardness test; and

FIG. 7 illustrates an example of the present invention being applied to the Knoop hardness test.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

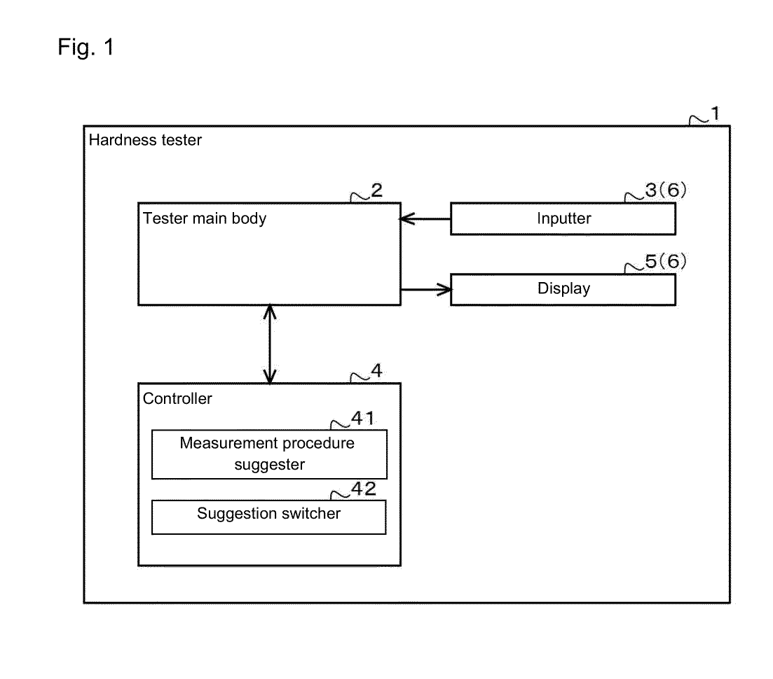

Hereafter, an embodiment of the present invention is described with reference to the drawings. FIG. 1 is a block diagram illustrating a schematic configuration of a hardness tester 1 according to the embodiment of the present invention. As shown in FIG. 1, the hardness tester 1 includes a tester main body 2, an inputter 3 which receives an operation input by a user, a controller 4 which controls an entirety of the hardness tester 1 including the inputter 3, and a display 5 which displays a predetermined image by being controlled by the controller 4. The inputter 3 and the display 5 are configured integrally with a touch panel 6 in the present embodiment. Moreover, even though the inputter 3 and the display 5 are configured integrally with the touch panel 6 in the present embodiment, they may be configured separately. For example, a keyboard and a mouse may be used as inputters and a liquid crystal display or the like may be used as a display.

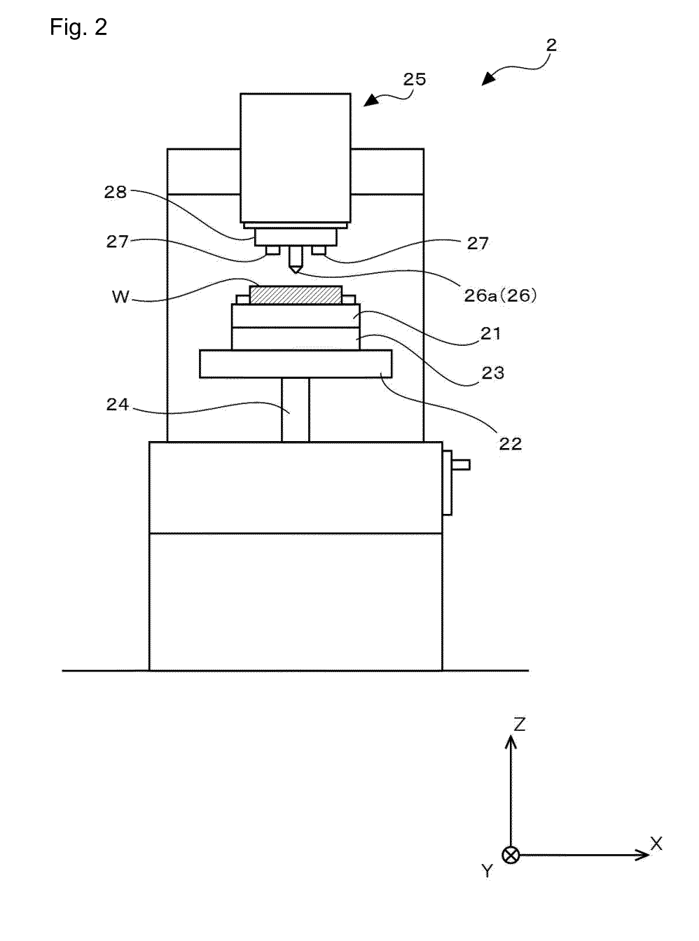

FIG. 2 is a schematic view illustrating an external appearance of a tester main body 2 when viewed from the front. As shown in FIG. 2, the tester main body 2 includes a table 21 on which a work piece W is placed, an XY stage 22 which displaces the table 21 in a left-right direction (X axis direction) and a front-back direction (Y axis direction), a Z stage 23 which displaces the table 21 in an up-down direction (Z axis direction), an elevator mechanism 24 which elevates the XY stage 22 and the Z stage 23, and a hardness testing portion 25 which is provided above the table 21 and executes a hardness test of the work piece W.

The hardness testing portion 25 includes an indenter column 26 having an indent 26a on a tip thereof, a field lens 27 capturing images of the work piece W, and a turret 28 which switches positions of the indenter column 26 and the field lens 27 by self-rotating of the turret, as well as supporting the indenter column 26 and the field lens 27. Furthermore, in addition to the indenter column 26, the field lens 27, and the turret 28, the hardness tester 25 includes an illumination device for illuminating a surface of the work piece W by firing light, and a CCD (Charge Coupled Device) camera and the like for capturing images of the surface of the work piece W via the field lens 27 (not shown in the drawings).

The controller 4 is configured by a CPU (Central Processing Unit), a memory, and the like and executes information processing according to a predetermined program. As shown in FIG. 1, the controller 4 includes a measurement procedure suggester 41 and a suggestion switcher 42. The measurement procedure suggester 41 suggests a procedure for measuring an indentation dimension value to the user. The suggestion switcher 42 switches, when the user receives the operation input for proceeding via the touch panel 6, suggestions from the measurement procedure suggester 41 to suggest a next (also referred to as “following” or “subsequent”) procedure to the user.

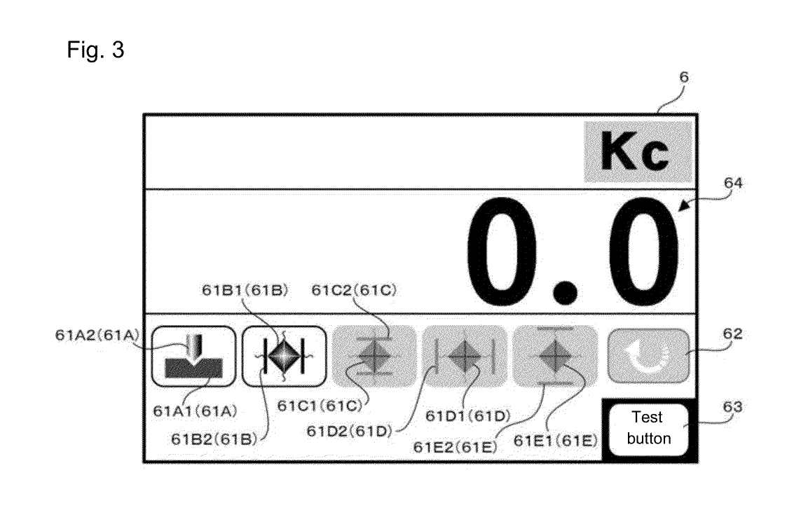

FIG. 3 is a schematic view illustrating an image displayed on the touch panel 6. Specifically, as shown in FIG. 3, the measurement procedure suggester 41 suggests the procedure for measuring the indentation dimension value to the user, by displaying a plurality of icons 61A through 61E in a substantially central region of the touch panel 6, which are images of each procedure for measuring the indentation dimension value. Moreover, in the present embodiment, performing a fracture toughness (Kc) test is described as an example. FIG. 3 shows a screen displayed on the touch panel 6 when executing the fracture toughness (Kc) test.

An icon 61A is configured with an image 61A1 showing a work piece W, and an image 61A2 showing an indenter 26a. The icon 61A suggests a procedure for forming an indentation by pressing the indenter 26a against a surface of the work piece W to a user. An icon 61B is configured with an image 61B1 showing an indentation and cracks, and a linear image 61B2 showing a measuring portion of the indentation dimension value. The icon 61B suggests a procedure for measuring a lateral length of a diagonal line of the indentation without cracks to a user, in the direction of the paper. An icon 61C is configured with an image 61C1 showing an indentation and cracks, and a linear image 61C2 showing a measuring portion of the indentation dimension value. The icon 61C suggests a procedure for measuring a vertical length of the diagonal line of the indentation without the cracks to a user, in the direction of the paper.

An icon 61D is configured with an image 61D1 showing an indentation and cracks, and a linear image 61D2 showing a measuring portion of the indentation dimension value. The icon 61D suggests a procedure for measuring a lateral length of the diagonal line of the indentation including cracks to a user, in the direction of the paper. An icon 61E is configured with an image 61E1 showing an indentation and cracks, and a linear image 61E2 showing a measuring portion of the indentation dimension value. The icon 61E suggests a procedure for measuring the vertical length of the diagonal line of the indentation including cracks to a user, in the direction of the paper.

Moreover, the controller 4 displays a cancel button 62 in a right region of the icons 61A to 61E. The touch panel 6 receives a signal indicating the cancel button 62 being pressed down as the operation input for returning to the previous procedure. In addition, the controller 4 displays a test button 63 in a lower region of the cancel button 62. The touch panel 6 receives a signal indicating the test button 63 being pressed down as the operation input for forming an indentation. Furthermore, the controller 4 displays a dimension value input area 64 in an upper region of the icons 61A to 61E. The dimension value input area 64 is described later.

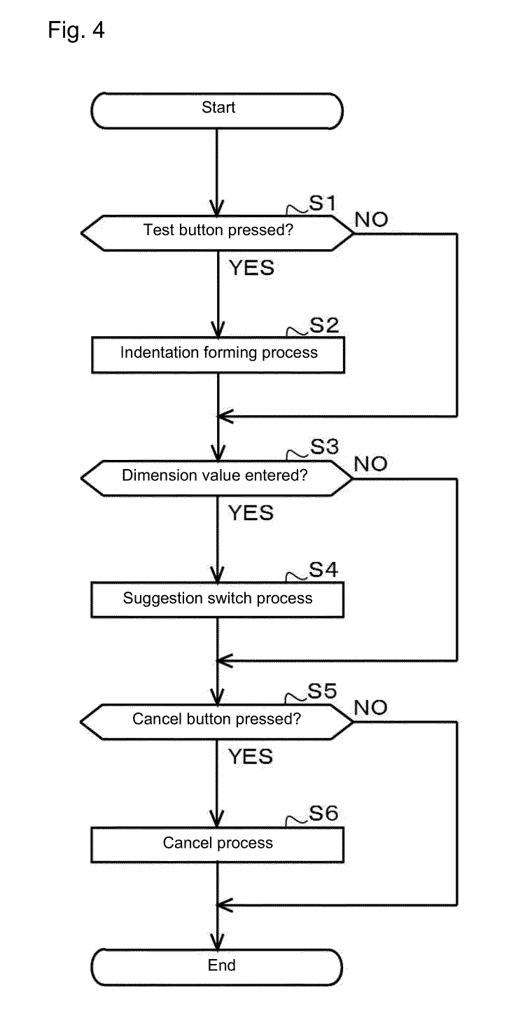

FIG. 4 shows a flowchart illustrating a case where a test is performed with the hardness tester 1. As shown in FIG. 4, the controller 4 regularly executes steps S1 through S6 when a test is performed by the hardness tester 1. In step S1, the controller 4 determines whether the test button 63 has been pressed. When step S1 determines that the test button 63 has not been pressed, the controller 4 executes the process beginning at step S3 without executing the process in step S2. Meanwhile, the controller 4 executes an indentation forming process in step S2 when step S1 determines that the test button 63 has been pressed.

In the indentation forming process in step S2, the controller 4 forms an indentation having the indenter 26a pressed against the surface of the work piece W by driving the elevator mechanism 24 to elevate the XY stage 22 and Z stage 23. Moreover, before pressing the test button 63, the user positions the indenter column 26 above the work piece W by rotating the turret 28, and prepares for the test moving the table 21 by displacing the XY stage 22 and Z stage 23. In other words, the user can form the indentation at a desired position on the work piece W by moving the table 21.

After executing the indentation forming process in step S2, or when it is determined at step S1 that the test button 63 has not been pressed, the controller 4 executes the process beginning at step S3. In step S3, the controller 4 determines whether the dimension value has been entered via the touch panel 6.

Moreover, the user can enter the dimension value in the dimension value input area 64 by operating the touch panel 6, after measuring the dimension value by observing the indentation formed on the work piece W, based on captured images via the field lens 27 and a CCD camera. The dimension value entered in the dimension value input area 64 is stored in a memory of the controller 4. In addition, the controller 4 calculates the hardness of the work piece W by using the dimension value stored in the memory. The hardness tester 1 performs hardness testing of the work piece W by forming the indentation by pressing the indenter 26a against the surface of the work piece W, and by measuring the indentation dimension value.

When it is determined at step S3 that the dimension value has not been entered via the touch panel 6, the controller 4 executes the process beginning at step S5 without executing the process in step S4. Meanwhile, when it is determined at step S3 that the dimension value has been entered via the touch panel 6, the controller 4 executes a suggestion switch process in step S4.

In the suggestion switch process in step S4, the suggestion switcher 42 switches suggestions by emphasizing (i.e., highlighting) the icon indicating the next procedure among a plurality of icons 61A through 61E, while not emphasizing the icon showing the current procedure. Accordingly, the suggestion switcher 42 switches suggestions from the measurement procedure suggester 41 to suggest the next procedure to the user. In other words, the suggestion switcher 42 switches suggestions from the measurement procedure suggester 41 to suggest the next procedure to the user, when receiving the input of the indentation dimension value via the touch panel 6 (operation input for proceeding).

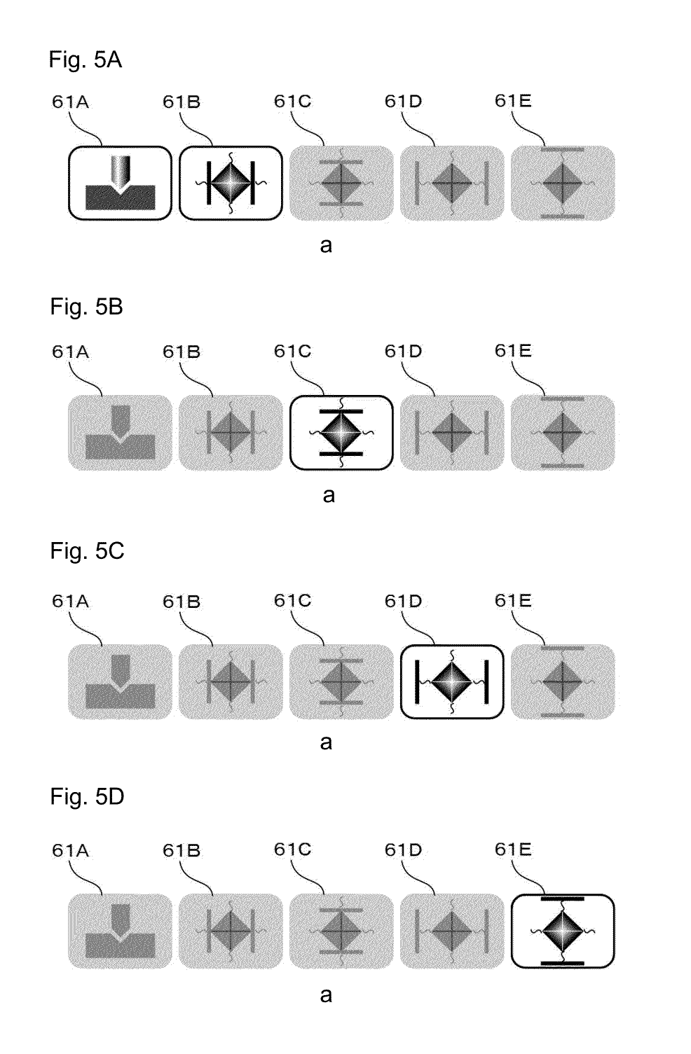

FIGS. 5A to 5D illustrate states of switching suggestions from the measurement procedure suggester 41 at the suggestion switcher 42. As shown in FIG. 5A, when starting the hardness tester 1, the icons 61A and 61B are emphasized among the icons 61A through 61E, while not emphasizing icons 61C to 61E (initial state). In this initial state, when it is determined at step S3 that the dimension value has been entered via the touch panel 6, the suggestion switcher 42 causes the icon 61C to be emphasized while not emphasizing icons 61A and 61B as shown in FIG. 5B.

Moreover, in the state of the FIG. 5B, when it is determined at step S3 that the dimension value has been entered via the touch panel 6, the suggestion switcher 42 causes the icon 61D to be emphasized while not emphasizing the icon 61C as shown in FIG. 5C. Furthermore, in the state of the FIG. 5C, when it is determined at step S3 that the dimension value has been entered via the touch panel 6, the suggestion switcher 42 causes the icon 61E to be emphasized while not emphasizing the icon 61D as shown in FIG. 5D.

After executing the suggestion switch process in step S4, or when it is determined at step S3 that the dimension value has not been entered via the touch panel 6, the controller 4 executes the process beginning at step S5. In step S5, the controller 4 determines whether the cancel button 62 has been pressed. When it is determined at step S5 that the cancel button 62 has not been pressed, the controller 4 ends the process without executing the process in step S6. On the other hand, when it is determined at step S5 that the cancel button 62 has been pressed, the controller 4 executes a cancel process in step S6.

In the cancel process in step S6, the suggestion switcher 42 switches suggestions from the measurement procedure suggester 41 to suggest the previous procedure to the user. In other words, when receiving the operation input for returning to the previous procedure via the touch panel 6, the suggestion switcher 42 switches suggestions from the measurement procedure suggester 41 to suggest the previous procedure to the user. Specifically, for example, when it is determined at step S5 that the cancel button 62 has been pressed in the state of FIG. 5D, the suggestion switcher 42 causes the icon 61D to be emphasized while not emphasizing the icon 61E as shown in FIG. 5C. Furthermore, when it is determined at step S5 that the cancel button 62 has been pressed in the initial state previously mentioned, the suggestion switcher 42 maintains the suggestion, without switching, from the measurement procedure suggester 41.

In the cancel process in step S6, the suggestion switcher 42 deletes the indentation dimension value entered when the current procedure is processed. In other words, when receiving the operation input for returning to the previous procedure via the touch panel 6, the suggestion switcher 42 deletes, from the memory, the dimension value entered when the current procedure is processed and resets the value to “0”.

In the indentation forming process previously described in step S2, the suggestion switcher 42 causes the icons 61A and 61B to be emphasized while not emphasizing the icons 61C to 61E regardless of the state of the current icons 61A through 61E. In other words, when forming the indentation by having the indenter 26a pressed against the surface of the work piece W, the suggestion switcher 42 causes the icons 61A and 61B indicating the first procedure to be emphasized, while not emphasizing the icons 61C to 61E indicating other procedures, and initializes suggestions from the measurement procedure suggester 41.

In this way, the following effects and advantages can be achieved according to the present embodiment: (1) The hardness tester 1 includes the measurement procedure suggester 41 which can suggest the procedure for measuring the indentation dimension value to the user. In addition, when receiving the operation input for proceeding to the next procedure via touch panel 6, the hardness tester 1 includes the suggestion switcher 42 which can switch suggestions from the measurement procedure suggester 41 to suggest the next procedure to the user. Thus, according to the present embodiment, the user can easily determine a designated portion of the indentation border based on the suggestion from the measurement procedure suggester 41.

(2) The measurement procedure suggester 41 displays a plurality of icons 61A through 61E on the touch panel 6, which are images showing each procedure for measuring the indentation dimension value, and suggests the procedure for measuring the indentation dimension value to the user. Therefore, the user can intuitively determine the designated portion of the indentation border with reference to these icons 61A through 61E. Thus, according to the present embodiment, the user can easily determine the designated portion of the indentation border based on the suggestion from the measurement procedure suggester 41.

(3) The suggestion switcher 42 initializes suggestions from the measurement procedure suggester 41 when forming the indentation by pressing the indenter 26a against the surface of the work piece W. Therefore, it is possible to automatically initialize suggestions from the measurement procedure suggester 41 when starting a test. Thus, according to the present embodiment, it is possible to improve convenience of the hardness tester 1.

(4) When receiving the operation input for returning to the previous procedure via the touch panel 6, the suggestion switcher 42 switches suggestions from the measurement procedure suggester 41 to suggest the previous procedure to the user. Therefore, the user can easily restore to an original state simply by the operation input for returning to the previous procedure via the touch panel 6 even if the user mistakenly executes the operation input to proceed to the next procedure via the touch panel 6. Thus, according to the present embodiment, it is possible to improve convenience of the hardness tester 1.

(5) The suggestion switcher 42 receives the input of the indentation dimension value as the operation input for proceeding to the next procedure. Therefore, the user can switch suggestions from the measurement procedure suggester 41 to the next procedure simply by entering the indentation dimension value. Thus, according to the present embodiment, it is possible to improve convenience of the hardness tester 1.

(6) When receiving the operation input for returning to the previous procedure via the touch panel 6, the suggestion switcher 42 deletes the indentation dimension value which was entered when the current procedure is processed. Therefore, the user can delete the indentation dimension value when the current procedure is processed simply by the operation input for returning to the previous procedure via the touch panel 6. Thus, according to the present embodiment, it is possible to improve convenience of the hardness tester 1.

Moreover, the present invention is not limited to the above-described embodiments, and includes modifications and improvements within a scope capable of achieving the advantages of the present invention. For example, in the previously mentioned embodiment, the measurement procedure suggester 41 suggests the procedure for measuring the indentation dimension value to the user by displaying a plurality of icons 61A through 61E which are images of each procedure for measuring the indentation dimension value. However, it is possible to suggest the procedure for measuring the indentation dimension value to the user by using sound for example. In short, a measurement procedure suggester should be able to suggest a procedure for measuring indentation dimension value to a user.

In the previously mentioned embodiment, when the indentation has been formed by pressing the indenter 26a against the surface of the work piece W, the suggestion switcher 42 initializes suggestions from the measurement procedure suggester 41. However, the initialization is not necessary. In addition, for example, it is possible for the controller 4 to initialize suggestions from the measurement procedure suggester 41, by displaying a new button and the like on the touch panel 6 to execute the initialization when the user presses the button.

In the previously mentioned embodiment, when receiving the operation input for returning to the previous procedure via the touch panel 6, the suggester switcher 42 suggests the previous procedure to the user by switching the suggestion from the measurement procedure suggester 41, and deletes the indentation dimension value entered when the current procedure is processed. However, this function does not need to be included. In the previously mentioned embodiment, the suggestion switcher 42 receives the input of the indentation dimension value as the operation input for proceeding to the next procedure. However, for example, other operation input such as pressing down a button can be received as an operation input for proceeding.

In the previously mentioned embodiment, executing the fracture toughness (Kc) test is described as an example. However, the present invention can be applied to other test methods such as the Vickers hardness (HV) and the Knoop hardness (HK) tests.

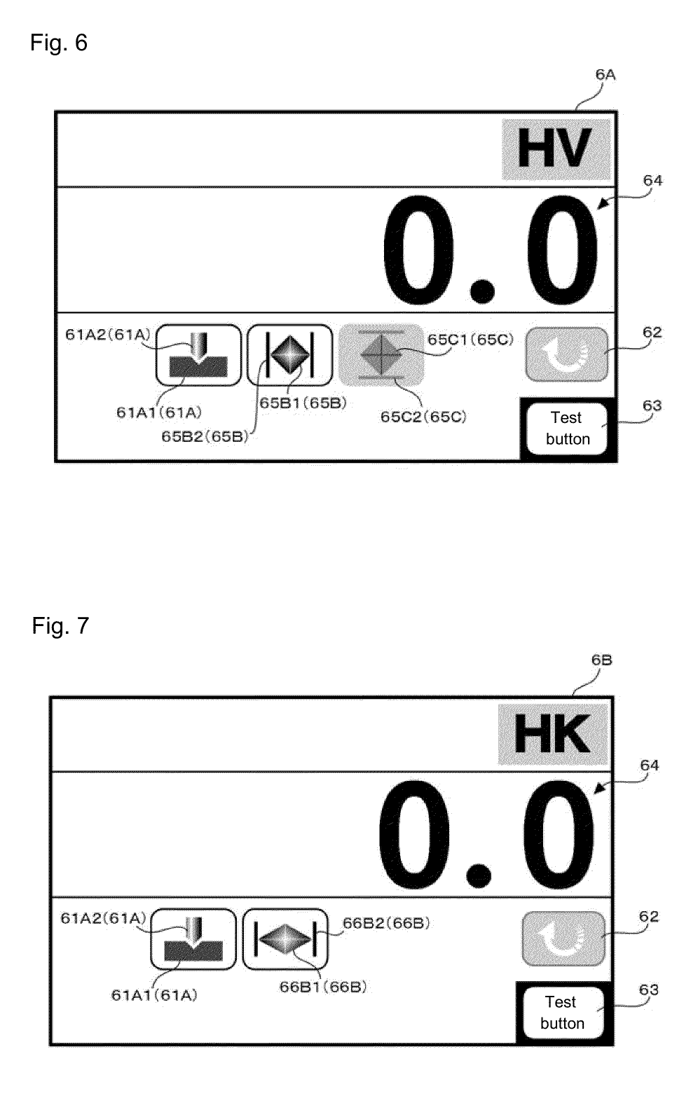

FIG. 6 illustrates an example of the present invention applied to the Vickers hardness test. For example, in a case applying the present invention to the Vickers hardness (HV) test, as shown in FIG. 6, the measurement procedure suggester 41 displays a plurality of icons 61A, 65B, and 65C in a substantially center region of the touch panel 6A, which are images showing each procedure when measuring indentation dimension value, and suggests the procedure for measuring the indentation dimension value to the user.

The icon 61A is configured with an image 61A1 showing the work piece W and an image 61A2 showing the indenter 26a. The icon 61A suggests the procedure for forming the indentation by pressing the indenter 26a against the surface of the work piece W to the user. The icon 65B is configured with an image 65B1 showing the indentation and a linear image 65B2 showing portions of measuring the indentation dimension value. The icon 65B suggests the procedure for measuring the lateral length of the diagonal line of the indentation to the user, in the direction of the paper. The icon 65C is configured with an image 65C1 showing the indentation and a linear image 65C2 showing portions of measuring the indentation dimension value. The icon 65C suggests the procedure for measuring the lateral length of the diagonal line of the indentation to the user, in the direction of the paper.

FIG. 7 illustrates an example of the present invention applied to the Knoop hardness test. For example, in a case where the present invention is applied to the Knoop hardness (HK) test, as shown in FIG. 7, the measurement procedure suggester 41 displays a plurality of icons 61A and 66B in a substantially center region of the touch panel 6B, which are images showing each procedure when measuring the indentation dimension value, and suggests the procedure for measuring the indentation dimension value to the user.

The icon 61A is configured with an image 61A1 showing the work piece W and an image 61A2 showing the indenter 26a. The icon 61A suggests the procedure for forming the indentation by pressing the indenter 26a against the surface of the work piece W to the user. The icon 66B is configured with an image 66B 1 showing the indentation and a linear image 66B2 showing the portions of measuring the indentation dimension value. The icon 66B suggests the procedure for measuring the lateral length of the diagonal line of the indentation to the user, in the direction of the paper.

As noted above, the present invention can be used with a hardness tester.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A hardness tester for testing a hardness of a work piece by forming an indentation by pressing an indenter against a surface of the work piece, and by measuring an indentation dimension value, comprising:
an inputter configured to receive an operation input from a user; and
a controller configured to control an entirety of the hardness tester including the inputter, the controller comprising:
a measurement procedure suggester configured to suggest to the user a procedure for measuring the indentation dimension value; and
a suggestion switcher configured to switch, when receiving an operation input for proceeding to a subsequent procedure via the inputter, suggestions from the measurement procedure suggester to suggest to the user the subsequent procedure.

2. The hardness tester according to claim 1, further comprising:
a display on which a predetermined image is displayed by being controlled by the controller;
wherein, the measurement procedure suggester is further configured to suggest to the user the procedure for measuring the indentation dimension value, by displaying on the display a plurality of icons which are images of each procedure for measuring the indentation dimension value; and
the suggestion switcher is further configured to cause an icon showing a subsequent procedure to be highlighted among a plurality of icons while not highlighting an icon showing a current procedure, and is further configured to switch suggestions from the measurement procedure suggester so as to suggest to the user the subsequent procedure.

3. The hardness tester according to claim 2, wherein when forming an indentation by pressing an indenter against a surface of a work piece, the suggestion switcher causes an icon showing a first procedure to be highlighted while not highlighting the icons showing other procedures, and further initializes suggestions from the measurement procedure suggester.

4. The hardness tester according to claim 2, wherein when receiving an operation input for returning to a previous procedure via the inputter, the suggestion switcher switches suggestions from the measurement procedure suggester to suggest to the user the previous procedure.

5. The hardness tester according to claim 3, wherein when receiving an operation input for returning to a previous procedure via the inputter, the suggestion switcher switches suggestions from the measurement procedure suggester to suggest to the user the previous procedure.

6. The hardness tester according to claim 1, wherein the suggestion switcher is configured to receive an input of the indentation dimension value as the operation input for proceeding to a subsequent procedure.

7. The hardness tester according to claim 2, wherein the suggestion switcher is configured to receive an input of the indentation dimension value as the operation input for proceeding to a subsequent procedure.

8. The hardness tester according to claim 3, wherein the suggestion switcher is configured to receive an input of the indentation dimension value as the operation input for proceeding to a subsequent procedure.

9. The hardness tester according to claim 4, wherein the suggestion switcher is configured to receive an input of the indentation dimension value as the operation input for proceeding to a subsequent procedure.

10. The hardness tester according to claim 5, wherein the suggestion switcher is configured to receive an input of the indentation dimension value as the operation input for proceeding to a subsequent procedure.

11. The hardness tester according to claim 6, wherein when receiving the operation input for returning to a previous procedure via the inputter, the suggestion switcher deletes the indentation dimension value entered when the current procedure is processed.

12. The hardness tester according to claim 7, wherein when receiving the operation input for returning to a previous procedure via the inputter, the suggestion switcher deletes the indentation dimension value entered when the current procedure is processed.

13. The hardness tester according to claim 8, wherein when receiving the operation input for returning to a previous procedure via the inputter, the suggestion switcher deletes the indentation dimension value entered when the current procedure is processed.

14. The hardness tester according to claim 9, wherein when receiving the operation input for returning to a previous procedure via the inputter, the suggestion switcher deletes the indentation dimension value entered when the current procedure is processed.

15. The hardness tester according to claim 10, wherein when receiving the operation input for returning to a previous procedure via the inputter, the suggestion switcher deletes the indentation dimension value entered when the current procedure is processed.
